(19) United States
(12) Patent Application Publication
(10) Pub. No.: US 2015/0284215 A1
(43) Pub. Date: Oct. 8, 2015

(54) ELEVATOR, AND IMPROVEMENT FOR REDUCING ELONGATION OF THE ROPING OR BELTING OF THE ELEVATOR IN A LOADING SITUATION OF THE CAR OF THE ELEVATOR, AND THE USE OF PRETENSIONING FOR BRACING THE ROPING OR BELTING OF THE ELEVATOR

(71) Applicants: Pentti ALASENTIE, Espoo (FI); Esko AULANKO, Kerava (FI); Matti RÄSÄNEN, Hyvinkaa (FI)

(72) Inventors: Pentti ALASENTIE, Espoo (FI); Esko AULANKO, Kerava (FI); Matti RÄSÄNEN, Hyvinkaa (FI)

(73) Assignee: Kone Corporation, Helsinki (FI)

(21) Appl. No.: 14/711,459

(22) Filed: May 13, 2015

Related U.S. Application Data
(63) Continuation of application No. PCT/FI2013/051069, filed on Nov. 12, 2013.

(30) Foreign Application Priority Data
Nov. 16, 2012 (FI) 20126205

(51) Int. Cl. B66B 5/12; B66B 11/00

(52) U.S. Cl. CPC B66B 5/12; B66B 11/009

(57) ABSTRACT

Elevator, comprising:
a car of the elevator and a counterweight that are to be moved reciprocally;
at least one roping or belting traveling via a top pulley assembly for connecting the car of the elevator and the counterweight to each other via the top pulley assembly;
at least one roping or belting traveling via a bottom pulley assembly for connecting the car of the elevator and the counterweight to each other via the bottom pulley assembly.

At least one roping or belting traveling via the bottom pulley assembly is pretensioned or can be pretensioned.

An improvement for reducing elongation of the roping or belting of an elevator in a loading situation of the car of the elevator is produced when an elevator according to the invention is used in such a way that at least one roping or belting traveling via the bottom pulley assembly is pretensioned, in which case owing to the pretensioning at least one roping or belting traveling via the top pulley assembly and at least one roping or belting traveling via the bottom pulley assembly interact in such a way that the elasticity of the connected roping or belting to be formed in this way decreases compared to the situation before pretensioning.

This application is a continuation of PCT International Application No. PCT/FI2013/051069 which has an International filing date of Nov. 12, 2013, and which claims priority to Finnish patent application number 20126205 filed Nov. 16, 2012, the entire contents of both of which are incorporated herein by reference.

### FIELD OF THE INVENTION

The invention relates to the field of elevator technology and more particularly to the implementation of ropings or beltings to be used in elevators.

### TECHNICAL BACKGROUND

The car of an elevator is usually suspended by means of roping or belting e.g. on a counterweight via a pulley assembly fixed to the roof of the elevator. Elongation of the roping or belting in a loading situation of the car of the elevator depends in this case on how far the car of the elevator is from the suspension pulley assembly. Elongation of the roping or belting in a loading situation is generally at its greatest when the distance of the car of the elevator from the suspension pulley assembly is at its greatest.

In practice this is because when the car of the elevator is at one of the lowermost floors of the building in which it is located—such as e.g. when the car of the elevator is at the basement floor, from which most of the passengers or load of the elevator come into the car—the elongation of the roping or belting is at its greatest in a loading situation.

It is not uncommon for elevator passengers to experience the elongation of the roping or belting in a loading situation as unpleasant, because in fact the car of the elevator displaces downwards from below the feet as the load of the car increases, whereas the expectation of a passenger would be for the car of the elevator to remain in its position.

Elastic elongation of the roping or the belting affects the sill height of an elevator car at a floor level. The ideal is that there is no sill between the floor level and the floor of the elevator car, and it is to be hoped that such a sill is not disturbing. When the elevator car is loaded, the roping tries to elongate and the floor of the elevator car sinks downwards, in which case a tripping hazard or other impediment can occur, e.g. the transfer of a wheelchair or a child's pushchair into the elevator car or out of the elevator car can become more difficult. The elongation differences of the roping caused by the loading at any given time of the elevator car might affect the accuracy of a run to a floor. Conventionally, the elevator car of a modern elevator is kept accurately at the level with the accurate leveling function of the moving machine. In this case, however, the brakes of the elevator must be kept open.

### AIM OF THE INVENTION

The aim of the invention is to reduce elongation of the roping or belting in a loading situation of the car of an elevator.

### BRIEF DESCRIPTION OF THE INVENTION

This aim can be resolved by using an elevator according to claim 1 and improvement according to claim 7 for reducing elongation of the roping or belting of the elevator in a loading situation of the car of the elevator, and with the use of pretensioning according to claim 8 for bracing the roping or belting of the elevator.

The dependent claims describe preferred embodiments of the elevator.

### ADVANTAGES OF THE INVENTION

The elevator according to the invention comprises
a) a car of the elevator and a counterweight that are to be moved reciprocally;
b) at least one roping or belting traveling via a top pulley assembly for connecting the car of the elevator and the counterweight to each other via the top pulley assembly; and
c) at least one roping or belting traveling via a bottom pulley assembly for connecting the car of the elevator and the counterweight to each other via the bottom pulley assembly.

In addition to this, in the elevator at least one roping or belting traveling via the bottom pulley assembly is pretensioned or can be pretensioned.

Pretensioning to a certain minimum tension can be performed in advance and/or it can be performed from time to time, possibly even for each load separately. Pretensioning from time to time, i.e. occurring in operating situations of the elevator, is preferably performed e.g. by pulling the end of the roping or belting traveling via the bottom pulley assembly with a suitable pulling device, e.g. with a spring. The desired pretensioning can be locked to act on the loading during the next run of the elevator. Preferably the roping or belting traveling via the bottom pulley assembly is pretensioned by acting on the section between the elevator car and the bottom pulley assembly, particularly in those cases where the bottom pulley assembly is prevented from rotating.

The inventors have noticed that the dynamics of the car of the elevator and of the counterweight can be modeled with a relatively simple mechanical spring model. When the car of the elevator, said car being loaded or to be loaded, acts as the mass, the roping or belting can be modeled as a type of spring.

The inventors have made the surprising observation that the elongation of the roping or belting in response to an increase (cf spring constant) in the load of the car of the elevator decreases when the car of the elevator and the counterweight are connected to each other not only via the top pulley assembly but also via the bottom pulley assembly using roping or belting for the connecting and when the connecting is implemented in such a way that at least one roping or belting traveling via the bottom pulley assembly is pretensioned.

As a result of the invention it is possible to use in elevators ropes or belts of a high strength class at least in respect of one roping or belting at least as some of the ropes or belts. Ropes or belts of a high strength class are in principle too ductile for them to be used in elevators. They are, however, lighter because a rope or belt bearing a corresponding load is thinner and thus they offer an opportunity to make the motor needed for moving the car of the elevator smaller and in addition to this, or alternatively, to save energy when the mass to be moved is smaller.

Since the top pulley assembly, the bottom pulley assembly, or both, can both be braked with at least one brake, the braking force can be exerted on just the top pulley assembly, on just the bottom pulley assembly or on both. In this way it is possible to influence wear of the brakes and roping. Since both the top pulley assembly and the bottom pulley assembly can be braked, the braking force can be improved, which enables an increase in braking power or alternatively the braking power needed can be realized with lighter brake components.

When the elevator comprises tensioning means for tensioning the roping or belting, the precision needed in installing an elevator can be decreased and the servicing need reduced. According to a preferred embodiment the tensioning means are configured, or can be configured, to tension the roping or the belting traveling via the bottom pulley assembly. The tensioning means most preferably comprise a lock and a spring. The tensioning means preferably also comprise a tensioning limiter, which prevents and/or even discharges the pretensioning if the pretensioning is growing or grows to be too great.

An improvement for reducing elongation of the roping or belting of an elevator in a loading situation of the car of the elevator emerges when some elevator according to the invention is used in such a way that at least one roping or belting traveling via the bottom pulley assembly is pretensioned, in which case owing to the pretensioning at least one roping or belting traveling via the top pulley assembly and at least one roping or belting traveling via the bottom pulley assembly interact in such a way that the elasticity of the connected roping or belting to be formed in this way decreases compared to the situation before pretensioning.

The inventive concept is expressed as use of pretensioning for bracing the roping or belting of an elevator. Preferably the pretensioning force of the pretensioning is the magnitude of the weight of the nominal load permitted for the elevator car. The pretensioning force can also be other than this and it can be selected to be suitable according to the typical use or momentary use of the elevator. In the embodiments hereinafter some suitable methods for pretensioning are described.

Preferably the invention is applied in elevators in which the contact between the roping or belting of the pulley belonging to the bottom pulley assembly pulling the elevator or belonging to the top pulley assembly pulling the elevator is gripping, e.g. owing to a high friction coefficient or owing to toothing of the belts of the belting.

Preferably the invention is applied in such a way that the pretensioning is changed in the stressed part of the roping traveling via the bottom pulley.

When using pretensioning for improving the bracing of the roping in a loading situation, it is advantageous to prevent during loading of the elevator car the rotation of the top pulley assembly or bottom pulley assembly, or both, of the roping to be braced. A good way to prevent rotation is to prevent the rotation of one or more pulleys, which belong(s) to the top pulley assembly or bottom pulley assembly, by the aid of a brake device acting on the pulley in question.

The invention can be applied to elevators with machine above and to elevators with machine below. The inventors believe that an elevator with machine below is a more advantageous solution.

### LIST OF DRAWINGS

In the following the invention will be presented in more detail by the aid of some embodiments described by FIGS. 1 and 2.

FIG. 1 presents a schematic view of the car of an elevator and a counterweight, which are connected to each other by the aid of ropings traveling via both a top pulley assembly and a bottom pulley assembly;

FIG. 2 presents a schematic view of an elevator corresponding to FIG. 1, in which is also marked to be visible a motor and tensioning means.

The same reference numbers refer to the same parts in both FIGs.

### DETAILED DESCRIPTION

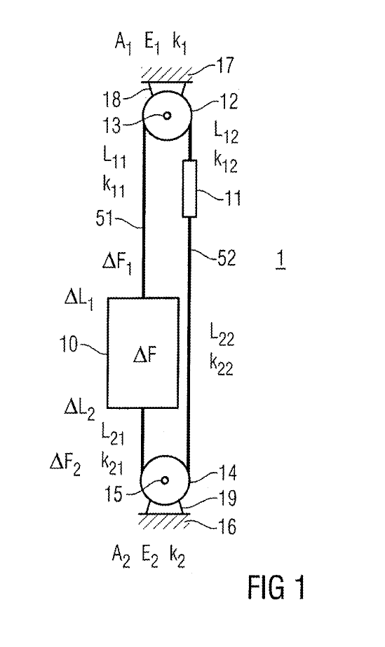

The displacement during loading of the car 10 of the elevator 1 according to FIG. 1 can be reduced, or the displacement can be minimized or even totally eliminated, by pretensioning the displacement ropes 51, 52 of the supporter force.

In a conventional elevator the elasticity of the displacement ropes causes a displacement of the car during loading. The supporter is the rope between the car and the machine. The displacement is at its maximum when the car is at the bottommost level. In a conventional elevator the supporters between the machine and the traction sheave participate in supporting the load coming into the car.

In the elevator 1 according to the invention the car 10 and the counterweight 11 are connected in such a way that the displacement rope 51 passes around a pulley assembly (pulley 12 and shafting 13) that is rigidly fixed in the top end of the elevator hoistway and the displacement rope 52 passes around a pulley assembly (pulley 14 and shafting 15) that is rigidly fixed in the bottom end of the elevator hoistway in such a way that the length of the “supporter loop” thus produced remains constant and pretensioning is performed on this loop. The displacement during loading of the car 10 essentially decreases because the displacement ropes 51, 52, i.e. the whole loop, support the car 10.

One of the two pulleys 12, 14 is the traction sheave of the machine of the elevator 1. During the loading the brake of the machine prevents rotation of the traction sheave 12, 14 (the brake acts at the point of the supporter 18, 19 on the side of the traction sheave). The elevator 1 can also comprise a second brake, which prevents the rotation of the second pulley 12, 14 and the movement of the supporters (the brake acts at the point of the supporter 18, 19 of the pulley on the opposite side to the traction sheave).

The system thus produced is significantly stiffer than a conventional elevator system. The amount of leveling starts of the electric drive of the drive machinery of the elevator 1 can be essentially reduced and comfort in the car 10 improved when the movement of the car 10, particularly on the bottommost floor (which is in most cases the main floor) can be reduced to somewhere around one one-hundredth of what is conventional.

In high-rise buildings the lateral swinging of the displacement ropes caused by swaying of the building is a problem. When the displacement ropes 51, 52 are pretensioned between two rigidly fixed pulleys 12, 14, the amplitude during lateral swinging of the displacement ropes 51, 52 is smaller than in a conventional solution, in which the pulley 14 of the bottom end of the hoistway is able to move in the vertical direction.

In a conventional solution the own mass of the displacement ropes cannot be reduced by using displacement ropes of a high strength class, because the flexing of the displacement ropes would become too great. In the elevator 1 according to the invention the use of displacement ropes of a high strength class as the displacement ropes 51, 52 is possible owing to the increased load-bearing cross-section.

There follows an example calculation for an elevator 1 comprising steel ropes as the displacement ropes 51, 52:

According to our model, the bulk factor of the cable is 0.622 and the cable weighs 1.2 kg/m.

According to our model, the elongation ΔLᵢ of each displacement rope 51, 52 is proportional to the change ΔFᵢ in the force acting at any given time on the displacement rope 51, 52 in question:

ΔFᵢ=kᵢΔLᵢ (1.1).

On the other hand, the change in the force is exerted on both ropes:

ΔF₁+ΔF₂=ΔF (1.2).

The change ΔLᵢ in the length of each displacement rope 51, 52 is equal

ΔL₁=ΔL₂ (1.3).

According to its definition, for the spring constant:

$${k}_{i} = \frac{{A}_{i} {E}_{i}}{{L}_{i}} . \qquad ( 1.4 )$$

On the basis of equations (1.4), (1.1) and (1.3), we can write:

$$\frac{Δ {F}_{1}}{{k}_{1}} = \frac{Δ {F}_{2}}{{k}_{2}} = \frac{Δ F - Δ {F}_{2}}{{k}_{2}} . \qquad ( 1.5 )$$

From this we can solve ΔF₁:

$$Δ {F}_{1} = \frac{{k}_{1}}{{k}_{1} + {k}_{2}} Δ F . \qquad ( 1.6 )$$

On the basis of equation (1.1) we can write:

$$Δ {L}_{1} = \frac{Δ {F}_{1}}{{k}_{1}} \qquad ( 1.7 )$$

in which k₁ and k₂ can be determined separately for each of the cases we want.

The general parameters of our model can be seen in Table 1:

TABLE 1
general parameters

| Pretensioning force | | | | | |
|---|---|---|---|---|---|
| → nominal load | 0.00 | 0.25 | 0.50 | 0.75 | 1.00 |
| Load of car (%) | 100 | 100 | 100 | 100 | 100 |
| Load (kg) | 1800 | 1800 | 1800 | 1800 | 1800 |
| Distance (m) | 240 | 240 | 240 | 240 | 240 |
| Nominal load (kg) | 1800 | 1800 | 1800 | 1800 | 1800 |
| Car + displacement | 3450 | 3450 | 3450 | 3450 | 3450 |
| ropes | | | | | |
| Average brake | 149832 | 149832 | 149832 | 149832 | 149832 |
| force (min.) | | | | | |
| E1 (N/mm²) | 75000 | 75000 | 75000 | 75000 | 75000 |
| E2 (N/mm²) | 75000 | 75000 | 75000 | 75000 | 75000 |
| A1 tot. (mm²) | 841 | 841 | 841 | 841 | 841 |
| A2 tot. (mm²) | 803 | 803 | 803 | 803 | 803 |
| k11 (N/m) | 259585 | 344695 | 512839 | 1001257 | 21026394 |
| k21 (N/m) | 21026394 | 1001257 | 512839 | 344695 | 259585 |
| k21 (N/m) | 20072195 | 955819 | 489566 | 329052 | 247805 |
| k21 (N/m) | 247805 | 329052 | 489566 | 955819 | 20072195 |
| k1a (N/m) | 256419 | 256419 | 256419 | 256419 | 256419 |
| k2a (N/m) | 244783 | 244783 | 244783 | 244783 | 244783 |

Case 1: The top pulley 12 is braked and the bottom pulley 14 is free to rotate.

$${k}_{1} = {k}_{11} = \frac{{A}_{1} {E}_{1}}{{L}_{11}}$$

$${k}_{12} = \frac{{A}_{1} {E}_{1}}{{L}_{12}}$$

$${k}_{2 a} = \frac{{A}_{2} {E}_{2}}{{L}_{12} + {K}_{22}}$$

$${k}_{2} = \frac{{k}_{12} {k}_{2 a}}{{k}_{12} + {k}_{2 a}}$$

The data for Case 1 are in Table 2.

We observe that if the traction sheave 12 in the top end or the traction sheave 14 in the bottom end must be braked, the corresponding displacement in the top end or in the bottom end is 35.2 mm, i.e. approx. one-half compared to the conventional elevator system presented below.

TABLE 2

| Pretensioning force → | | | | | | |
|---|---|---|---|---|---|---|
| nominal load | | 0.00 | 0.25 | 0.50 | 0.75 | 1.00 |
| k1 | (N/m) | 259585 | 344695 | 512839 | 1001257 | 21026394 |
| k2 | (N/m) | 241966 | 196696 | 165695 | 143136 | 125983 |
| dF1 | (kg) | 932 | 1146 | 1360 | 1575 | 1789 |
| dF2 | (kg) | 868 | 654 | 440 | 225 | 11 |
| dL car | (mm) | 35.2 | 32.6 | 26.0 | 15.4 | 0.8 |
| 75 kg dL car | (mm) | 1.5 | 1.4 | 1.1 | 0.6 | 0.0 |

Case 2: the bottom pulley 14 is braked and the top pulley 12 is free to rotate:

$${k}_{1} = \frac{{k}_{1 a} {k}_{22}}{{k}_{1 a} + {k}_{22}}$$

$${k}_{1 a} = \frac{{A}_{1} {E}_{1}}{{L}_{11} + {L}_{12}}$$

$${k}_{22} = \frac{{A}_{2} {E}_{2}}{{L}_{22}}$$

$${k}_{2} = {k}_{21} = \frac{{A}_{2} {E}_{2}}{{L}_{21}}$$

The data for Case 2 are in Table 3.

TABLE 3

| Pretensioning force → | | | | | | |
|---|---|---|---|---|---|---|
| nominal load | | 0.00 | 0.25 | 0.50 | 0.75 | 1.00 |
| k1 | (N/m) | 126019 | 144115 | 168280 | 202180 | 253185 |
| k2 | (N/m) | 20072195 | 955819 | 489566 | 329052 | 247805 |
| dF1 | (kg) | 11 | 236 | 460 | 685 | 910 |
| dF2 | (kg) | 1789 | 1564 | 1340 | 1115 | 890 |
| dL car | (mm) | 0.9 | 16.1 | 26.8 | 33.2 | 35.2 |

Case 3: the bottom pulley 14 is braked and the top pulley 12 is braked:

$${k}_{1} = {k}_{11} = \frac{{A}_{1} {E}_{1}}{{L}_{11}}$$

$${k}_{2} = {k}_{21} = \frac{{A}_{2} {E}_{2}}{{L}_{21}}$$

The data for Case 3 are in Table 4. We observe that if the pulleys 12, 14 of both the top end and the bottom end are kept in their position with a brake, the displacement of the car 10 of our example case is 17.6 mm, i.e. approx. one-quarter of the displacement of a corresponding conventional solution.

TABLE 4

| Pretensioning | | | | | | |
|---|---|---|---|---|---|---|
| force | | | | | | |
| → nominal load | | 0.00 | 0.25 | 0.50 | 0.75 | 1.00 |
| k1 | (N/m) | 259585 | 344695 | 512839 | 1001257 | 21026394 |
| k2 | (N/m) | 20072195 | 955819 | 489566 | 329052 | 247805 |
| dF1 | (kg) | 23 | 477 | 921 | 1355 | 1779 |
| dF2 | (kg) | 1777 | 1323 | 879 | 445 | 21 |
| dL car | (mm) | 0.9 | 13.6 | 17.6 | 13.3 | 0.8 |
| 75 kg | (mm) | 1.5 | 1.4 | 1.1 | 0.6 | 0.0 |
| dL car | | | | | | |

Data for the non-pretensioned elevator are presented in Table 5. As we observe, elongation of the displacement ropes of a conventionally designed elevator being implemented with the same dimensioning would produce with the nominal load a displacement of 68.0 mm of the car.

TABLE 5

| Pretensioning | | | | | | |
|---|---|---|---|---|---|---|
| force → | | | | | | |
| nominal load | | 0.00 | 0.25 | 0.50 | 0.75 | 1.00 |
| k1 | (N/m) | 259585 | 344695 | 512839 | 1001257 | 21026394 |
| dL car | (mm) | 68.0 | 51.2 | 34.4 | 17.6 | 0.8 |
| 75 kg dL car | (mm) | 2.8 | 2.1 | 1.4 | 0.7 | 0.0 |

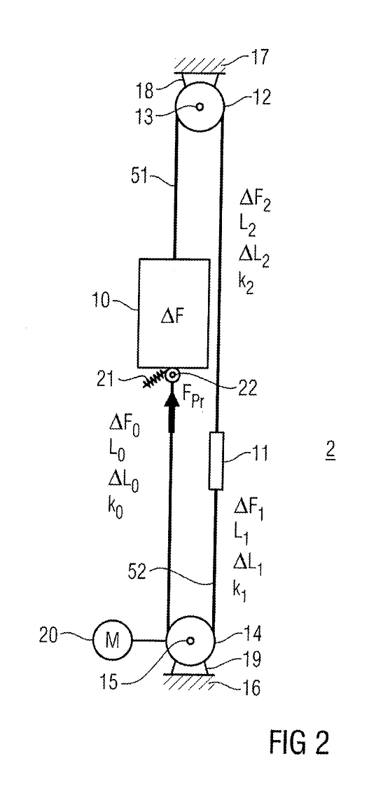

FIG. 2 presents an elevator of the type of FIG. 1, wherein also marked to be visible are a motor 20 and a tensioning unit, which comprises a spring 21 and a lock 22. The lock 22 is installed in connection with the car 10.

According to the markings presented in FIG. 2 we can write

ΔL₀=ΔL₁+ΔL₂ (2.1)

and

ΔF=ΔF₀+ΔF₂ (2.2).

For the spring constant kᵢ the following still holds true:

$${k}_{i} = \frac{{A}_{i} {E}_{i}}{{L}_{i}} \qquad ( 2.3 )$$

likewise for the forces

ΔF₁=ΔF₂ (2.4).

Also in the case of FIG. 2 we can write:

$$\begin{matrix}Δ {F}_{i} = {k}_{i} Δ {L}_{i} \\ and & ( 2.5 ) \\ Δ {L}_{i} = \frac{Δ {F}_{i}}{{k}_{i}} . & ( 2.6 )\end{matrix}$$

By inserting and solving we obtain:

$$\begin{matrix}\frac{Δ {F}_{0}}{{k}_{0}} = \frac{Δ {F}_{1}}{{k}_{1}} + \frac{Δ {F}_{2}}{{k}_{2}} = Δ {F}_{2} ( \frac{1}{{k}_{1}} + \frac{1}{{k}_{2}} ) & ( 2.7 ) \\ \frac{Δ F - Δ {F}_{2}}{{k}_{0}} = \frac{Δ {F}_{2}}{{k}_{1}} + \frac{Δ {F}_{2}}{{k}_{2}} \\ and & ( 2.8 ) \\ Δ {F}_{2} = \frac{Δ F}{\frac{1}{{k}_{0}} + \frac{1}{{k}_{1}} + \frac{1}{{k}_{2}}} . & ( 2.9 )\end{matrix}$$

When the pretensioning force of the roping is marked Fₚᵣ we obtain:

When Fₚᵣ>ΔF₀ in a situation in which the length of the roping is L_{0, maximum},

in a situation in which the change in force is estimated to be maximal, we obtain:

$$Δ {F}_{0} = \frac{Δ F ( \frac{1}{{k}_{1}} + \frac{1}{{k}_{2}} )}{\frac{1}{{k}_{0}} + \frac{1}{{k}_{1}} + \frac{1}{{k}_{2}}} \qquad ( 2.10 )$$

from this it follows that

$$Δ {L}_{0 , p} = Δ {F}_{2} ( \frac{1}{{k}_{1}} + \frac{1}{{k}_{2}} ) \qquad ( 2.11 )$$

because the roping 51, 52 can be regarded as springs installed in parallel. When friction forces are ignored,

ΔF₁≈ΔF₂≈ΔF (2.12)

From which it follows that

$$Δ {L}_{0 , s} = Δ {L}_{1} + Δ {L}_{2} = Δ F ( \frac{1}{{k}_{1}} + \frac{1}{{k}_{2}} ) , \qquad ( 2.13 )$$

in which case for the relative change in length we obtain

$$\frac{Δ {L}_{0 , p}}{Δ {L}_{0 , s}} = \frac{1 / {k}_{0} / ( \frac{1}{{k}_{0}} + \frac{1}{{k}_{1}} + \frac{1}{{k}_{2}} )}{\frac{1}{{k}_{1}} + \frac{1}{{k}_{2}}}$$

For example, in a case in which

L₀=L₁, L₂=2L₀, A₀=A₁=0.5 A₂ and E₀=E₁=E₁

we obtain

$$\begin{matrix}\frac{{L}_{0 , p}}{{L}_{0 , s}} = \frac{{L}_{0} / {A}_{0} / ( \frac{{L}_{0}}{{A}_{0}} + \frac{{L}_{0}}{{A}_{0}} + \frac{2 {L}_{0}}{{A}_{0}} )}{\frac{{L}_{0}}{{A}_{0}} + \frac{2 {L}_{0}}{2 {A}_{0}}} \\ = \frac{1 / ( 1 + 1 + 1 )}{1 + 1} \\ = \frac{1}{6} .\end{matrix}$$

If, correspondingly, there were not pretensioning in the fabricated elevator, the elasticity, or the relative change in length, would be much larger because the ropings 51, 52 would behave as springs installed in series and not as springs installed in parallel.

The invention must not be regarded as being limited only to the claims below but instead should be understood to include all legal equivalents of said claims and combinations of the embodiments presented.

More particularly, instead of, or in addition to, the displacement ropes 51, 52 above, belts can be used. In the lattermost case, it is called displacement belting.

A person skilled in the art will also understand that use of the pretensioning of an elevator according to the invention for bracing the roping could also be expressed as a method wherein the roping is braced by the aid of pretensioning.

1. Elevator,
which comprises:
a car of the elevator and a counterweight that are to be moved reciprocally;
at least one roping or belting traveling via a top pulley assembly for connecting the car of the elevator and the counterweight to each other via the top pulley assembly;
at least one roping or belting traveling via a bottom pulley assembly for connecting the car of the elevator and the counterweight to each other via the bottom pulley assembly;
and in which at least one roping or belting traveling via the bottom pulley assembly is pretensioned or can be pretensioned.

2. Elevator according to claim 1, wherein the ropes or belts of at least one roping or belting are, or comprise, ropes or belts of a high strength class.

3. Elevator according to claim 1, wherein the top pulley assembly, the bottom pulley assembly, or both, can both be braked with at least one brake.

4. Elevator according to claim 1, which comprises tensioning means for tensioning the roping or belting.

5. Elevator according to claim 4, wherein the tensioning means are configured or can be configured to tension the ropes or the belting traveling via the bottom pulley assembly.

6. Elevator according to claim 4, wherein the tensioning means comprise a lock and a spring.

7. An improvement for reducing elongation of the roping or belting of an elevator in a loading situation of the car of the elevator, which improvement is produced in that an elevator according to claim 1 is used in such a way that at least one roping or belting traveling via the bottom pulley assembly is pretensioned, in which case owing to the pretensioning at least one roping or belting traveling via the top pulley assembly and at least one roping or belting traveling via the bottom pulley assembly interact in such a way that the elasticity of the connected roping or belting to be formed in this way decreases compared to the situation before pretensioning.

8. Use of pretensioning of the roping or belting traveling via the bottom pulley assembly for bracing the roping of an elevator, in an elevator that comprises:
a car of the elevator and a counterweight that are to be moved reciprocally;
at least one roping or belting traveling via a top pulley assembly for connecting the car of the elevator and the counterweight to each other via the top pulley assembly;
at least one roping or belting traveling via a bottom pulley assembly for connecting the car of the elevator and the counterweight to each other via the bottom pulley assembly.

9. Use according to claim 8, produced in that the pretensioning force of the pretensioning is the magnitude of the weight of the nominal load permitted for the elevator car.

10. Use according to claim 8, wherein rotation of the top pulley assembly and/or bottom pulley assembly of the roping to be braced is prevented in a loading situation of the elevator car.

11. Use according to claim 8, wherein in a loading situation the rotation of a pulley belonging to the top pulley assembly or to the bottom pulley assembly is prevented by the aid of a brake device.

12. Use according to claim 8, wherein in a loading situation the rotation of two or more pulleys belonging to the top pulley assembly or to the bottom pulley assembly is prevented by the aid of a brake device.

13. Use according to claim 12, wherein in a loading situation the rotation of at least one pulley belonging to the top pulley assembly is prevented and the rotation of at least one pulley belonging to the bottom pulley assembly is prevented.
